(19) United States
(12) Patent Application Publication
(10) Pub. No.: US 2012/0227037 A1
(43) Pub. Date: Sep. 6, 2012

(54) INSTALLATION SYSTEM AND METHOD FOR INSTALING VIRTUAL MACHINES

(75) Inventor: SEN-FENG CHANG, Tu-Cheng (TW)

(73) Assignee: HON HAI PRECISION INDUSTRY CO., LTD., Tu-Cheng (TW)

(21) Appl. No.: 13/221,860

(22) Filed: Aug. 30, 2011

(30) Foreign Application Priority Data
Mar. 1, 2011 (TW) 100106580

(51) Int. Cl. G06F 9/455

(52) U.S. Cl. 718/1

(57) ABSTRACT

A remote computer and method installs a virtual machine and one or more operating systems in cloud servers of a data center. The remote computer determines if each of the cloud servers has been successfully installed the virtual machine. The remote computer obtains the IP address of the cloud servers that have been successfully installed the virtual machine by the virtual machine controlling application. The remote computer sends an operating system image file to each of obtained cloud servers to install an operating system on the virtual machine of each of the obtained cloud servers according to the IP address of the obtained cloud servers.

### BACKGROUND

1. Technical Field

Embodiments of the present disclosure relate to installation technology, and particularly to an installation system and method.

2. Description of Related Art

A virtual machine (VM) is a software implementation that virtualizes a computer or a server on an operating system (kernel) layer. By using the VM, the multiple operating systems can co-exist and run independently on the same computer. Many VM are manually installed on computers by a user. However, if the virtual machines and the operating systems need to be installed on a large number of computers, it is not convenient and inefficient. More useful and convenient methods to install the virtual machines and the operating systems in the computers are desired by users.

### BRIEF DESCRIPTION OF THE DRAWINGS

FIG. 1 is a system view of one embodiment of an installation system.

FIG. 2 is a block diagram of one embodiment of a remote computer included in FIG. 1.

FIG. 3 is a flowchart of one embodiment of an installation method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

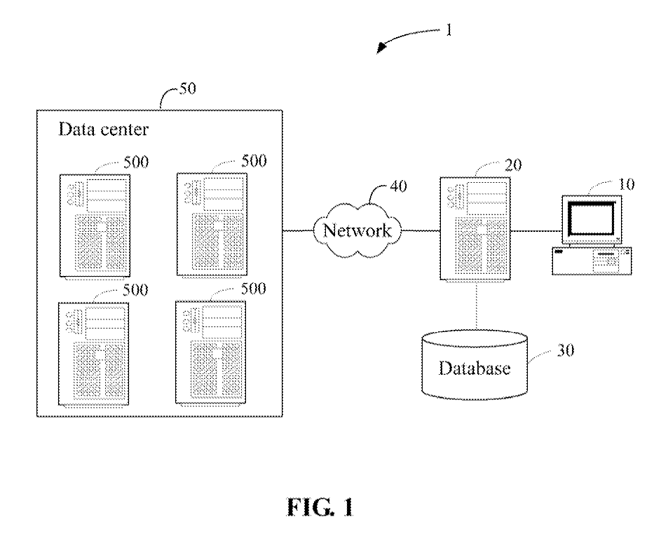

FIG. 1 is a system view of one embodiment of an installation system 1. In one embodiment, the installation system 1 may include a remote computer 20 and a data center 50. The data center 50 is designed for cloud computing capability and capacity and includes a plurality of cloud servers 500. The remote computer 20 is connected to the data center 50 via a network 40. The network 40 may be, but is not limited to, a wide area network (e.g., the Internet) or a local area network. The installation system 1 may be used to install a virtual machine and one or more operating systems in each of the cloud servers 500.

The remote computer 20 is installed with a pre-boot execute environment (PXE) service. The remote computer 20 can boot the cloud servers 500 by the PXE service.

The remote computer 20 stores a virtual machine image file and a virtual machine controlling application. It is understood that the virtual machine image file is defined as a compressed file that contains the complete contents and structures of a virtual machine. A user can use the virtual machine image file to install the virtual machine in the cloud servers 500. In one embodiment, the virtual machine image file may be, but is not limited to, a VMWARE ESX. It is understood that the virtual machine controlling application is defined as a software application that controls the virtual machine and installs one or more operating systems (e.g., MICROSOFT WINDOWS operating system or LINUX operating system) on the virtual machine. The virtual machine controlling application may be, but is not limited to, a VMWARE VCENTER server.

The remote computer 20, in one example, can be also a dynamic host configuration protocol (DHCP) server. The remote computer 20 is installed with a DHCP service. In one embodiment, the remote computer 20 assigns IP addresses to the cloud servers 500 by the DHCP service. The remote computer 20 may provide three modes for allocating IP addresses to the cloud servers 500. The modes are dynamic allocation, automatic allocation, and static allocation. In one embodiment, the remote computer 20 uses dynamic allocation to assign the IP addresses to the cloud servers 500. For example, when the remote computer 20 receives a request from a cloud server 500 via the network 40, the remote computer 20 dynamically assigns an IP address, and offers the remote computer 10 with the IP address. In one embodiment, the remote computer 20 may be a personal computer (PC), a network server, or any other data-processing equipment.

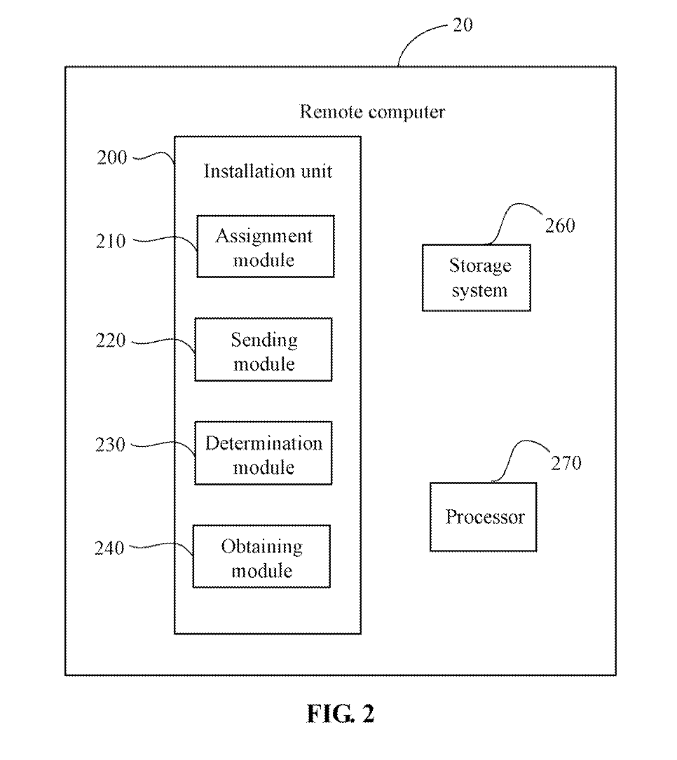

FIG. 2 is a block diagram of one embodiment of the remote computer 20. The remote computer 20 includes a virtual machine installation unit 200. The virtual machine installation unit 200 may be used to install the virtual machine in the cloud servers 500. In one embodiment, the remote computer 20 includes a storage system 260, and at least one processor 270. In one embodiment, the virtual machine installation unit 20 includes an assignment module 210, a sending module 220, a determination module 230, and an obtaining module 240. The modules 210-240 may include computerized code in the form of one or more programs that are stored in the storage system 260. The computerized code includes instructions that are executed by the at least one processor 270 to provide functions for the modules 210-240. The storage system 260 may be a cache or a memory, such as an EPROM, HDD, or flash memory.

The assignment module 210 assigns an IP address by the DHCP service to each of the cloud servers 500 of the data center 50 to communicate with each of the cloud servers 500.

The sending module 220 sends the virtual machine image file to each of the cloud servers 500 by the PXE service and installs the virtual machine in each of the cloud servers 500 using the virtual machine image file.

The determination module 230 determines if each of the cloud servers 500 has been successfully installed the virtual machine. In one embodiment, if the cloud servers 500 has been installed the virtual machine, the cloud servers 500 sends a feedback to the remote computer 20. The feedback may be a string, such as “ok!” or “successful!.” For example, the remote computer 20 has received the feedback from the cloud server A, it is indicated that the cloud server A has successfully installed the virtual machine.

The obtaining module 240 obtains the IP address of the cloud servers 500 that have successfully installed the virtual machine by the virtual machine controlling application.

The sending module 220 further sends an operating system image file to each of obtained cloud servers 500 to install an operating system on the virtual machine of the each of the obtained cloud servers 500 according to the IP address of the obtained cloud servers 500. It is understood that the operating system image file is defined as a compressed file that contains the complete contents and structures of the operating system. A user can use the operating system image file to install the operating system in the cloud servers 500.

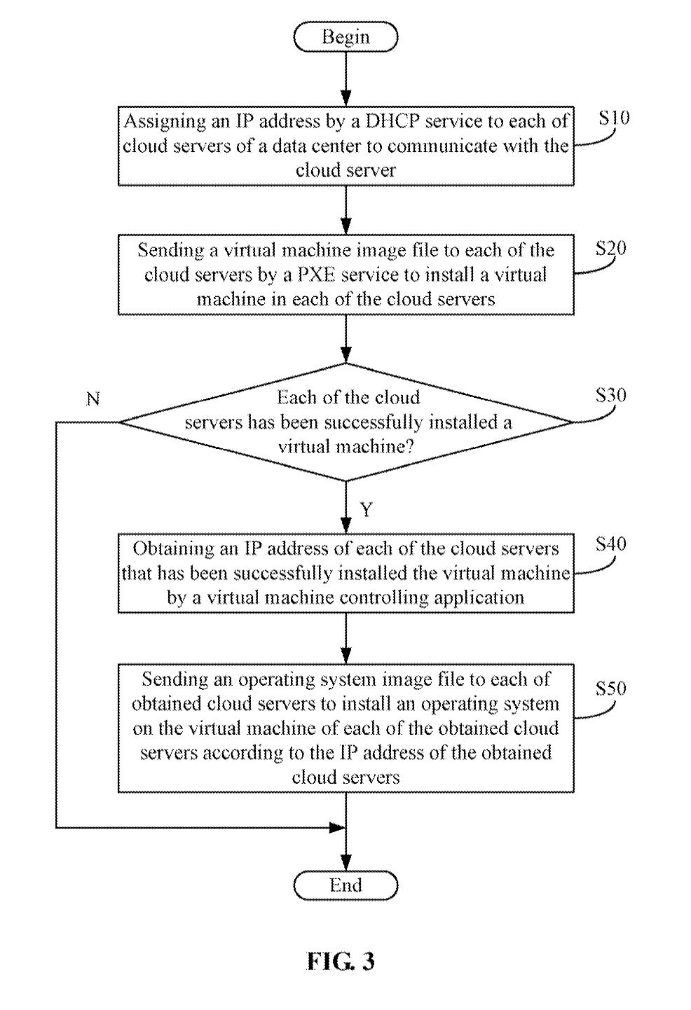

FIG. 3 is a flowchart of one embodiment of an installation method. Depending on the embodiment, additional blocks may be added, others deleted, and the ordering of the blocks may be changed.

In block S10, the assignment module 210 assigns an IP address by the DHCP service to each of the cloud servers 500 of the data center 50 to communicate with the cloud server 500.

In block S20, the sending module 220 sends the virtual machine image file to each of the cloud servers 500 by the PXE service and installs the virtual machine in each of the cloud servers 500 using the virtual machine image file.

In block S30, the determination module 230 determines if each of the cloud servers 500 has been successfully installed the virtual machine. In one embodiment, if a cloud server 500 has been installed the virtual machine, the cloud server 500 will send a feedback to the remote computer 20. The feedback may be a string, such as “ok!” or “successful!.” For example, if the remote computer 20 has received the feedback from the cloud server A, it is indicated that the cloud server A has been successfully installed the virtual machine, the procedure goes to block S40. Otherwise, if the remote computer 20 does not receive the feedback from all of the cloud servers 500, the procedure ends.

In block S40, the obtaining module 240 obtains the IP address of the cloud servers 500 that have successfully installed the virtual machine by the virtual machine controlling application.

In block S50, the sending module 220 further sends an operating system image file to each of the obtained cloud servers 500 to install an operating system on the virtual machine of each of the obtained cloud servers 500 according to the IP address of the obtained cloud servers 500.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer, the remote computer in electronic communication with cloud servers of a data center, comprising:
a storage system storing a virtual machine image file and a virtual machine controlling application;
at least one processor; and
one or more programs stored in the storage system and being executable by the at least one processor, the one or more programs comprising:
an assignment module operable to assign an IP address by a dynamic host configuration protocol (DHCP) service of the remote computer to each of the cloud servers to communicate with each of the cloud servers;
a sending module operable to send the virtual machine image file to each of the cloud servers by a pre-boot execute environment (PXE) service of the remote computer and installs the virtual machine in each of the cloud servers using the virtual machine image file;
a determination module operable to determine if each of the cloud servers has been successfully installed the virtual machine;
an obtaining module operable to obtain the IP address of the cloud servers that have been successfully installed the virtual machine by the virtual machine controlling application; and
the sending module operable to further send an operating system image file to each of obtained cloud servers to install an operating system on the virtual machine of each of the obtained cloud servers according to the IP address of the obtained cloud servers.

2. The remote computer of claim 1, wherein the virtual machine image file is a compressed file that contains the complete contents and structures of the virtual machine.

3. The remote computer of claim 1, wherein the virtual machine controlling application controls the virtual machine and installs one or more operating systems on the virtual machine.

4. The remote computer of claim 1, wherein the operating system image file is a compressed file that contains the complete contents and structures of the operating system.

5. A computer-based installation method being performed by execution of computer readable program code by a processor of a remote computer, the remote computer in electronic communication with cloud servers of a data center, the remote computer storing a virtual machine image file and a virtual machine controlling application, the method comprising:
assigning an IP address by a dynamic host configuration protocol (DHCP) service of the remote computer to each of the cloud servers to communicate with each of the cloud servers;
sending the virtual machine image file to each of the cloud servers by a pre-boot execute environment (PXE) service of the remote computer and installs the virtual machine in each of the cloud servers using the virtual machine image file;
determining if each of the cloud servers has been successfully installed the virtual machine;
obtaining the IP address of the cloud servers that have been successfully installed the virtual machine by the virtual machine controlling application; and
sending an operating system image file to each of obtained cloud servers to install an operating system on the virtual machine of each of the obtained cloud servers according to the IP address of the obtained cloud servers.

6. The method of claim 5, wherein the virtual machine image file is a compressed file that contains the complete contents and structures of the virtual machine.

7. The method of claim 5, wherein the virtual machine controlling application controls the virtual machine and installs one or more operating systems on the virtual machine.

8. The method of claim 5, wherein the operating system image file is a compressed file that contains the complete contents and structures of the operating system.

9. A non-transitory computer-readable medium having stored thereon instructions that, when executed by a remote computer, the remote computer in electronic communication with cloud servers of a data center, the remote computer storing a virtual machine image file and a virtual machine controlling application, causing the remote computer to perform an installation method, the method comprising:
assigning an IP address by a dynamic host configuration protocol (DHCP) service of the remote computer to each of the cloud servers to communicate with each of the cloud servers;
sending the virtual machine image file to each of the cloud servers by a pre-boot execute environment (PXE) service of the remote computer and installs the virtual machine in each of the cloud servers using the virtual machine image file;
determining if each of the cloud servers has been successfully installed the virtual machine;
obtaining the IP address of the cloud servers that have been successfully installed the virtual machine by the virtual machine controlling application; and
sending an operating system image file to each of obtained cloud servers to install an operating system on the virtual machine of each of the obtained cloud servers according to the IP address of the obtained cloud servers.

10. The non-transitory medium of claim 9, wherein the virtual machine image file is a compressed file that contains the complete contents and structures of the virtual machine.

11. The non-transitory medium of claim 9, wherein the virtual machine controlling application controls the virtual machine and installs one or more operating systems on the virtual machine.

12. The non-transitory medium of claim 9, wherein the operating system image file is a compressed file that contains the complete contents and structures of the operating system.
